(19) United States
(12) Patent Application Publication
(10) Pub. No.: US 2018/0154789 A1
(43) Pub. Date: Jun. 7, 2018

(54) BATTERY EXCHANGE SYSTEM

(71) Applicant: BattSwap Inc, Lewes, DE (US)

(72) Inventor: Radek Janku, Praha 6 (CZ)

(73) Assignee: BattSwap Inc., Lewes, DE (US)

(21) Appl. No.: 15/735,027

(22) PCT Filed: Jun. 9, 2016
(86) PCT No.: PCT/EP2016/063221

§ 371 Date: Dec. 8, 2017

Related U.S. Application Data
(60) Provisional application No. 62/173,716, filed on Jun. 10, 2015.

(51) Int. Cl. B60L 11/18; B60K 1/04; B60S 5/06; B66F 9/06

(52) U.S. Cl. CPC B60L 11/1822; B60L 11/1879; B60K 1/04; B60K 2001/0472; B66F 9/06; B60K 2001/0438; B60S 5/06

(57) ABSTRACT

A battery exchange system for a battery powered electric vehicle, comprising an interchangeable battery block, a battery dock defined at the underside of the electric vehicle to receive the battery block, and a battery lift for lifting the battery block underneath the electric vehicle. The battery block and the battery dock have guides adapted to mutually cooperate for guiding the battery block horizontally, and the battery lift is adapted to let the battery block move freely horizontally relative to the electric vehicle when the battery block is lifted for fitting with the battery dock.

### FIELD OF THE INVENTION

The invention relates to solid targets exchange and transport for particle accelerators such as cyclotrons.

### BACKGROUND OF THE INVENTION

The target material is typically manually loaded into the particle accelerator system. The irradiated target material is then transported to a shielded transport container either manually or semi-automatically. The shielding box is distributed manually to the target processing point and at the processing point, targets are again transported manually or semi-automatically. The overall process is time demanding and results in operator contact with the activated target.

### SUMMARY OF THE INVENTION

One objective of the present invention is to remedy these drawbacks. According to one embodiment, the invention proposes an automatic system for exchange and transport of solid targets from and to the particle accelerator comprising:
a transport system including a tube and at least two end stations;
a transport capsule;
a system for locking and unlocking the capsule;
a target manipulator;
an automatic target reloading device

In one particular embodiment, the invention relates to a universal automatic target reloading device for a low energy beam particle accelerator. One advantage of the embodiment is that the device enables fully automatic reloading of a target within the particle accelerator.

The transport capsules are also modified for the automated reloading of targets, for unlocking and then opening the capsule or closing and then locking the transport capsule. The target systems are extended with mechanisms for extracting (loading) the target, arresting the target, and positioning the target in the target holder for receipt of the particle beam.

represented by a shaped battery block, enabling a quick and inexpensive replacement battery in an electric vehicle.

The battery block may be formed by a shaped housing or external casing, in which connected battery cells are arranged. The shape of the housing can be a truncated pyramid with a rectangular base. The battery block can be provided with holes on the sides of the housing in a circumferential supporting frame for inserting mechanical locks. The housing may have electric connectors terminals on the upper side and position sensor on the lower side. The position sensor may be located in the geometric center of the bottom base of the housing and may be formed e.g. by a passive crystal or a mirror. The battery block may have tapered sides, preferably with a sliding surface. The battery block may further include a connector for data transfer.

The battery block may be fixed in a battery case or battery dock belonging to the electric vehicle, in such a way that the upper part of the housing is fixed using mechanical locks of the battery case and the bottom part of the battery may overlap the plane of the chassis.

The battery case may have a corresponding shape to fit the battery block and it may be firmly incorporated in the center tunnel of the vehicle chassis so that the lower part is flush with the lower edge of the chassis. The front-rear axis of the battery housing lies directly in the front-rear axis of the electric car.

The battery case may be connected to a backup power source, it may comprise a device for wireless communication with a control unit, electrical connectors, mechanical locks for attaching the battery and at least one position sensor. An One advantage of the battery in the center tunnel of the vehicle are minimal changes in the supporting structure of the car.

The battery case may be provided with sliding surfaces at least on sidelong sides to facilitate inserting the battery into the battery case. The sliding surfaces may be equipped with e.g. integrated beads, or silicone rollers. The mechanical lock may be a beveled latch connected through a spring with an electromechanical drive. The position sensor may be a pressure sensor. A device for wireless communication may be provided and is adapted for transmitting sensor signals to a control unit, for receiving communications and processing orders from the control unit. The battery case may further comprise a connector for data transfer and peripheral seal against moisture and dirt.

In one particular embodiment, the system for battery exchange may include a ramp, a trolley (or battery lift) for transport of batteries and a control unit. The system may advantageously comprise a smart card reader connected to the control unit.

The trolley transports battery blocks from a charging storage to a place underneath the vehicle. The trolley may be driven by its own power and may be equipped with a position sensor and a device for communication with the control unit. The trolley may be provided with two longitudinal pads (or platforms) with hoisting mechanisms (or lift assemblies), one for a charged battery and the other one for a discharged battery. The position sensor may be for example a source of infrared radiation or a laser beam. Each hoisting mechanism may include pistons or a jack driven by its own power (e.g. by a compressor). Both pads have a sliding surface to facilitate movement of the battery block on the pad, which may be formed for instance by a metal frame provided with silicone rollers, beads or bearings. The discharged battery pad is preferably equipped with a sort of funnel type bevel (tapered sides), which allows for adjusting a discharged battery position. The bevel has preferably a sliding surface.

The control unit may be a computer that provides communication with the trolley and battery case of the vehicle, and preferably also with a ramp (or more generally a vehicle lane) and said card reader. The control unit processes signals from position sensors of the trolley and battery housing and controls horizontal movement of the trolley under the vehicle. The control unit also controls the motion of the hoisting mechanisms of the trolley and movement of the mechanical locks. Communication of the control unit with the trolley, the ramp and/or the card reader may be direct (wired) or wireless, communication of the control unit with the battery case of the vehicle is wireless.

The ramp may be provided with a front wheel locking mechanism (blocking device) which may be equipped with a pressure sensor. Instead of a ramp, the vehicle lane may be also in a form of a platform in the plane of the road with an opening along the longitudinal axis of the vehicle, or include a hydraulic lifting platform for lifting the vehicle. The front wheel locking mechanism is preferably adjustable in the front-rear direction and is connected to the control unit. The position of the locking mechanism position may be adjusted in the longitudinal direction depending on the vehicle type. The front wheel locking mechanism may be a cradle.

The process of battery exchange includes transport of a charged battery from a charging storage into the battery case of the vehicle, as well as transport of a discharged battery from the battery case of the vehicle into the charging storage.

The process of battery exchange may involve the following steps:
1) a vehicle enters the ramp and its front wheels are locked in the locking mechanism,
2) a trolley with a charged battery arrives under the vehicle from a direction perpendicular to the longitudinal axis of the vehicle, the trolley stops on the basis of alignment of position sensors of the trolley and of the discharged battery,
3) the trolley hoists a longitudinal pad for the discharged battery and pushes it against the discharged battery to activate a (pressure, position) sensor of the battery case, which triggers a removal of mechanical locks from the battery holes followed by release of the discharged battery from the battery case,
4) the pad with the discharged battery then moves down to the starting (low) position,
5) the trolley is then moved by a constant predetermined distance so that the pad with a charged battery is directly under the battery case,
6) the charged battery is hoisted on the pad using a hoisting mechanism and pushed into the battery case to force mechanical locks to enter the holes on battery sides, this fixes the charged battery in the battery case of the vehicle and
7) the charged battery is fixed in the battery housing causes alignment of electrical connectors of the battery and the vehicle and their connection,
8) the pad for charged battery returns to its original (low) position, and then the trolley leaves for charging storage,
9) after releasing the front wheel locks, the vehicle departs.

A front-rear position of the vehicle may be set using an adjustable mechanism for adjusting the position of the locking mechanism on the ramp according to the distance between the front wheel axis and the front edge of the housing. This data specific to each type of vehicle will be kept in the vehicle's papers and preferably on a smart card. The vehicle is fixed on a ramp in the desired position by means of front wheel locking mechanism.

The trolley moves on rails and its movement is controlled by said control unit, as explained above. Lateral orientation of the trolley is ensured by the position sensors placed on the trolley and on the discharged battery. Signals from the position sensors are processed in the control unit, which urges the trolley to stop when the position sensors are above each other.

Inserting of the charged battery into the battery case is supported by its tapered (conical) shape and sliding surfaces of the battery as well as of the battery case. The inserted battery may slightly vertically overlap the vehicle chassis.

Connecting electrical connectors of the battery and the battery case indicates that the process of exchange has been successfully terminated.

The trolley departs for a charging storage, where the discharged battery is removed and another charged battery is loaded up on the trolley.

### BRIEF DESCRIPTION OF THE DRAWINGS

Other features and advantages of the invention appear from the following detailed description of several embodiments thereof, given by way of non-limiting examples, and with reference to the accompanying drawings.

In the drawings:

FIG. 1 is a schematic perspective view showing a battery block according to a first embodiment of the invention,

FIG. 1A is an end view of the battery block of FIG. 1,

FIGS. 1B to 1D are partial perspective views showing variants of the battery block of FIG. 1,

FIG. 2 is a perspective schematic view showing a battery dock for receiving the battery block of FIG. 1 under an electric vehicle, said battery dock being shown in inverted position

FIG. 3 shows a detail of a mechanical lock of the battery dock of FIG. 2,

FIGS. 4 and 4A show two variants of the battery lift (trolley) for transporting and lifting the battery blocks,

FIGS. 5 and 6 show a front wheel blocking device (locking mechanism) with a pressure sensor, adapted to be positioned in the vehicle lane to position the vehicle,

FIG. 7 is a front view of the vehicle when changing the battery block,

FIG. 8 is a side view of the vehicle when changing the battery block,

FIG. 9 is a schematic perspective view of a battery block according to a second embodiment of the invention, shown with mechanical locks belonging to the battery dock of the vehicle,

FIGS. 10 and 11 are respectively a top view and a side view of the battery block of FIG. 9,

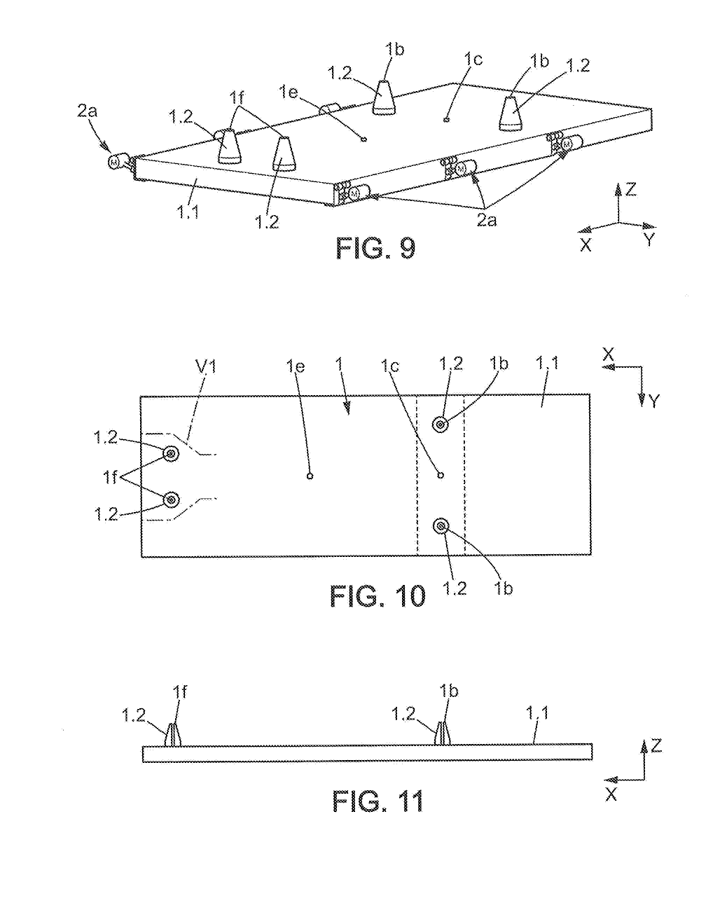

and FIGS. 12 and 13 are schematic section views of the battery block of FIG. 9 when received in the battery dock of the vehicle.

### MORE DETAILED DESCRIPTION

All the Figures are schematic; the dimensions of the various parts may be not always respected.

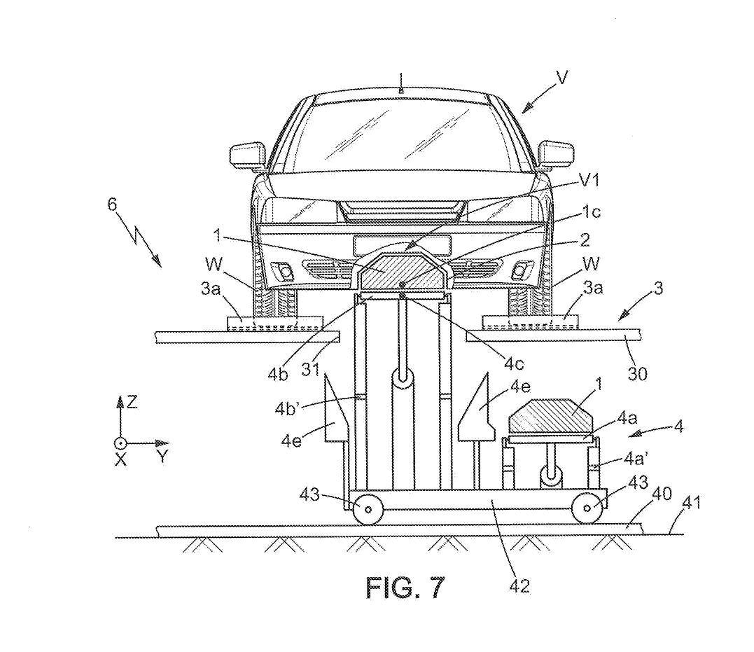

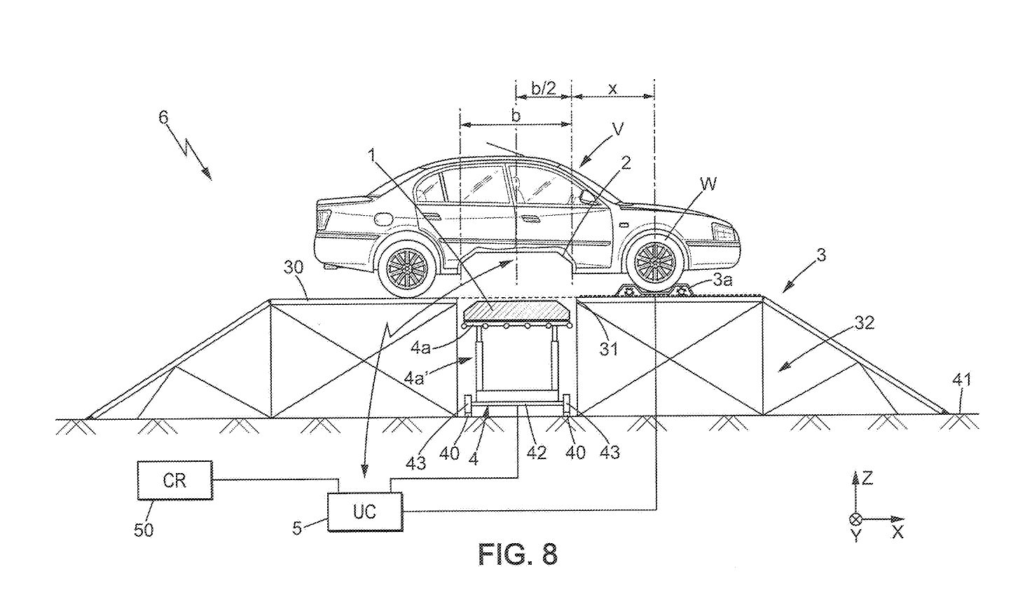

As best shown in FIGS. 7 and 8, the invention concerns a battery exchange system for a battery powered electric vehicle V. The electric vehicle V may be all electric or hybrid.

The battery exchange system comprises:
an interchangeable battery block 1;
a battery dock 2 fixed at the underside of the electric vehicle V (for instance in correspondence with the central tunnel of the electric vehicle V) and open downwards, said battery dock 2 being adapted to receive the battery block 1 for electrical and mechanical connection by vertical fitting when such battery is lifted from beneath the electric vehicle V;
a battery lift 4 for lifting the battery block 1 underneath the electric vehicle V for bringing a charged battery block 1 from a charging storage (not shown), removing a discharged battery block 1 from the battery dock, fitting the charged battery block in the battery dock 2 and transporting the discharged battery to the charging storage,
a control unit 5 (UC—FIG. 6) such as a computer or similar, for controling the battery lift 4 and in some examples for communicating with the battery dock 2, a wheel blocking device 3a for blocking for instance the front wheels W of the vehicle and a card reader 50 (CR) preferably situated at the entrance of the vehicle lane 3 by which the vehicle V may drive up to the wheel blocking device 3a.

The control unit 5 is adapted to position the battery lift 4 to enable it to take the discharged battery block from the electric vehicle, and substantially to a position where the charged battery block 1 is close to a reference position, which is the exact position enabling the charged battery block 1 to fit with the battery dock 2 when lifted in the vertical direction Z.

The charged battery block 1 need not be exactly in this reference position though, it can be offset from this reference position by a few centimeters in any of the horizontal directions X, Y (in this example, X is the longitudinal direction of the electric vehicle V and Y is the transverse direction).

To deal with such situation, the battery block 1 and the battery dock 2 have guides adapted to mutually cooperate for guiding the battery block 1 horizontally toward the reference position when the battery block 1 is lifted for fitting in the battery dock 2. Further, the battery lift 4 is adapted to let the battery block 1 move freely horizontally relative to the electric vehicle V when the battery block 1 is lifted for fitting in the battery dock 2 and guided horizontally toward the reference position.

Said guides may include at least one bevel shaped male part and at least one female part which is adapted to receive said bevel shaped male part, said bevel shaped male part and female part belonging, one to the battery block 1 and the other to the battery dock 2. In a addition or as a variant, said guides may include at least one male part and at least one funnel shaped female part which is adapted to receive said male part, said male part and funnel shaped female part belonging, one to the battery block 1 and the other to the battery dock 2. Of course, both the male and female parts can be bevelled shaped. The bevelled shaped male and/or female part may taper in one horizontal direction (particularly the transverse direction Y) or both horizontal directions X, Y, or in all horizontal directions (e.g. conical shape).

Said guides may include sliding surfaces which are adapted to slide on one another for guiding the battery block 1 horizontally toward the reference position. The sliding surfaces of the guides may be smooth and rigid surfaces able to freely slide on one another with low friction. One of the surface may be flat and the other may include sliding pads or beads or ribs or other refiefs. The sliding surfaces may be metallic; they can include an antifriction coating of low coefficient of coating, for instance Teflon (R) or other.

In a variant, said guides may include respectively at least a roller and a tapering surface on which said roller is adapted to roll for guiding the battery block 1 horizontally toward the reference position.

Regarding the way the free horizontal movement of the charged battery block 1 is obtained, the battery lift 4 may be adapted to be freely movable horizontally (at least in one direction, for instance the transverse direction Y or preferably in two directions) relative to the electric vehicle V when the battery block 1 is lifted for fitting in the battery dock 2 and guided horizontally toward the reference position. In a preferred variant or in addition to the above, the battery lift 4 may include a platform 4a for supporting the battery block 1 and a lift assembly 4a′ for raising and lowering the platform 4a, and the battery block 1 is freely movable horizontally on the platform 4a (said battery block 1 may be horizontally slidable on the platform 4a and/or rollingly supported on the platform 4a). The respective sliding surfaces of the battery block 1 and platform 4a which slide one on another may be smooth and rigid surfaces able to freely slide on one another with low friction. One of the surface may be flat and the other may include sliding pads or beads or ribs or other refiefs, or rolls rolling in a first direction and enabling free sliding in a second direction substantially perpendicular to the first direction. The sliding surfaces may be metallic; they can include an antifriction coating of low coefficient of coating, for instance Teflon (R) or other. The free movement of the battery block 1 on the platform 4a may be limited for instance by abutment to avoid having the battery block 1 fall from the platform 4a.

### First Embodiment

Interchangeable Battery Block

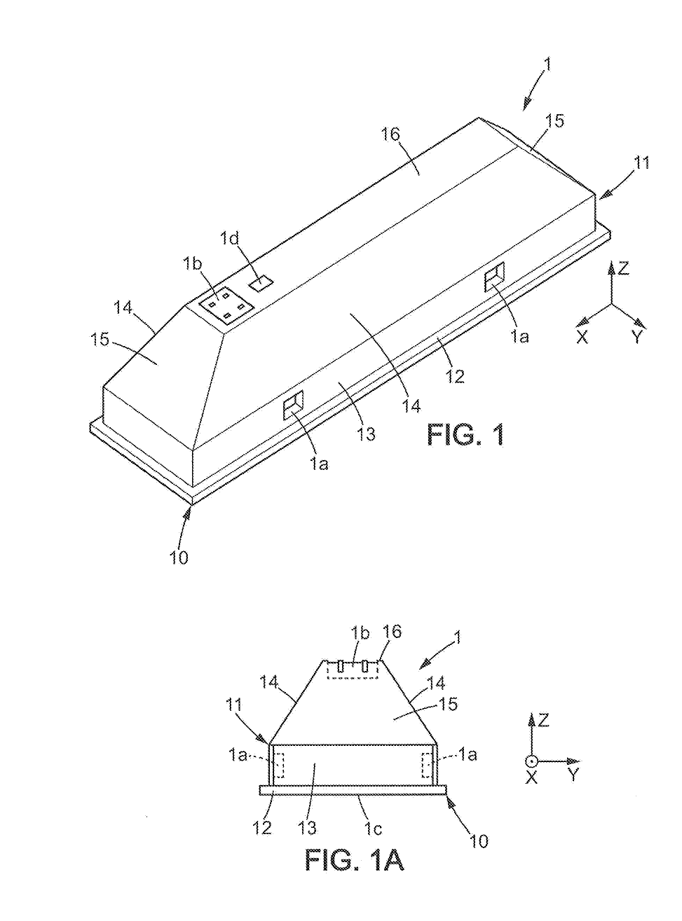

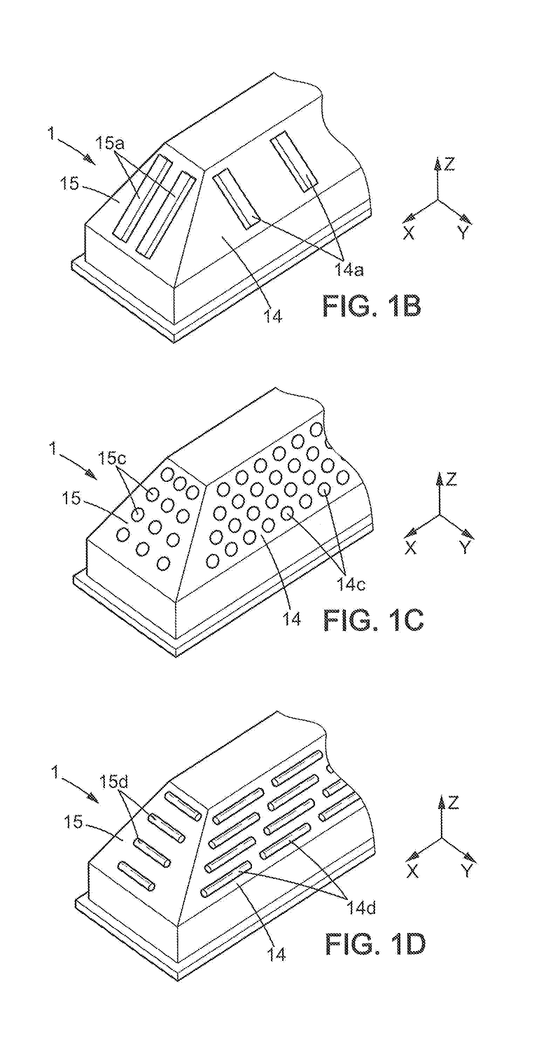

FIGS. 1, 1A show one example of the interchangeable battery block 1 according to the first embodiment of the invention.

In this first embodiment, the battery block 1 has an external casing 10 containing interconnected battery cells (not shown) and including a peripheral wall 11, a base 12 (which may for instance form a protruding ridge around the battery block 1) and a top portion 16. The peripheral wall 11 may have a lower part 13 of constant horizontal section and an upper pyramid shaped part forming said at least one bevel shaped male part.

The pyramid shaped part may include:
two bevelled longitudinal sides 14 parallel to direction X and converging upwardly in direction Y toward the top portion 16,
and two bevelled end sides 15 parallel to direction Y and converging upwardly in direction X toward the top portion 16.

The shape of the external casing 10 is thus here a truncated pyramid with a rectangular base and having a volume of for instance 150 liters. Typical dimensions for the external casing 10 can be: length 2000 mm, width 330 mm, height 240 mm.

The battery block may have an energy capacity of approximately 70 kWh, enabling a vehicle range of 300-500 km.

The lower part 13 of the peripheral wall 11 of the external casing 10 can form a circumferential supporting frame having holes 1a on its sides for inserting mechanical locks 2a from the battery dock.

The external casing 10 may have:
electric connector terminals 1b for instance on the top portion 16;
a data transfer connector 1d for instance on the top portion 16, fully concealed within the external casing 10 and the upper edge of the connector is flush with the top portion 16;
and a position sensor (e.g. a mirror) 1c located for instance in the geometric center of the base 12 of the external casing 10.

The two bevelled longitudinal sides 14 and/or the two bevelled end sides 15 may have sliding surfaces, for instance metallic surfaces or surfaces coated with an antifriction material, i.e. a low friction material such as Teflon (R) or similar. These sliding surfaces may form the entire surfaces of said bevelled sides or may be provided as sliding pads 14a, 15a (FIG. 1B) or sliding beads 14c, 15c (FIG. 1C) on said bevelled sides.

In a variant, as shown on FIG. 1D, the two bevelled longitudinal sides 14 and/or the two bevelled end sides 15 may have rollers 14d, 15d, in the form of rolling balls or rolls. In case the rollers are rolls, the rotation axis of the rollers 14d of bevelled sides 14 may be parallel to direction x and the rotation axis of the rollers 15d of bevelled sides 15 may be parallel to direction Y. The rollers may be made of or coated with silicone.

Battery Dock

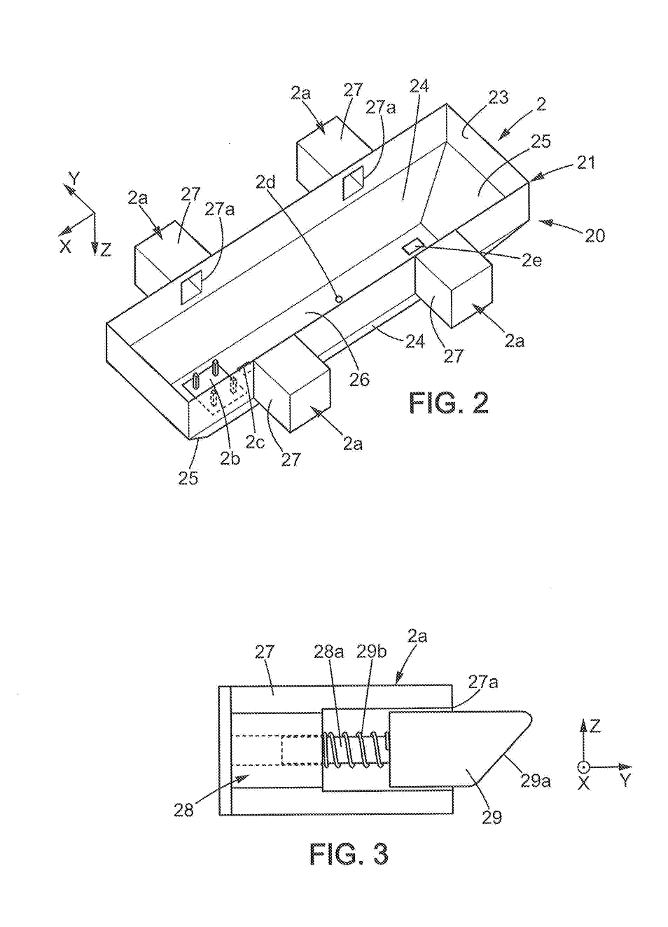

As shown in FIG. 2, the battery dock 2 has an internal casing 20 having preferably a shape corresponding to the external casing 10 of the battery block 1, to fit with the peripheral wall 11 of said external casing 10.

In the example of FIG. 2, the internal casing 20 has a peripheral wall 21 forming a lower opening, and a top portion 26.

The peripheral wall 21 may have a lower part 23 of constant horizontal section corresponding to that of said lower part 13 and an upper pyramid shaped part forming said at least one bevel shaped female part, of a shape corresponding to the shape of the pyramid shaped upper part 14, 15 of the peripheral wall 11 of the external casing 10.

The pyramid shaped part of peripheral wall 21 may include:
two bevelled longitudinal sides 24 parallel to direction X and converging upwardly in direction Y toward the top portion 26,
and two bevelled end sides 25 parallel to direction Y and converging upwardly in direction X toward the top portion 16.

The internal casing 20 may be firmly incorporated in the center tunnel V1 (very schematically shown on FIG. 6) of the vehicle chassis so the lower part thereof is flush with the lower edge of the chassis. The front-rear axis of the battery housing lies directly in the front-rear axis of the electric car, i.e. in direction X.

The battery dock 2 is preferably connected to a backup power source such as an internal battery mounted inside the vehicle. Battery dock 2 may comprise mechanical locks 2a for attaching the battery block 1, electrical connectors 2b, data transfer connectors 2c and a device 2e for wireless communication with the control unit 5 unit and a pressure sensor 2d.

As shown in FIGS. 2 and 3, the mechanical locks 2a may each include a housing 27, an electromechanical drive 28 driving a stem 28a and a latch 29 which includes a beveled front face 29a and is elastically connected to the stem 28a by a spring 29b. The beveled front face 29a faces partly downwards, such that when the latch 29 is in locking position (protruding inside the battery dock as shown on FIG. 3) the latch 29 is pushed backward into the housing 27 by camming effect by the battery block 1 when said battery block is being fitted with the battery dock 2. When said latch 29 faces the corresponding hole 1a of the battery block, it is automatically pushed inside said hole 1a by spring 29a. When the electromechanical drives 28 drive the stems 28a backward inside the housing 27, the latches 29 of the locks 2a are also driven inside the housing 27 and unlock the battery block 1.

The battery dock 2, and particularly beveled sides 24 and/or 25 (particularly sides 24), may also be provided with sliding surfaces and/or rollers similar to those described above with regard to the battery block 1. When the beveled sides 14, 15 are provided with beads or rollers, the corresponding sides 24, 25 may rather be flat surfaces.

Conversely, when the beveled sides 24, 25 are provided with beads or rollers, the corresponding sides 14, 15 may rather be flat surfaces.

The device 2e for wireless communication is adapted for transmitting signals from the pressure sensor 2d to the control unit 5, receiving communications and processing orders from the control unit 5.

The battery dock 2 may further comprise a peripheral seal against moisture and dirt.

Battery Exchange Station

The battery exchange system further includes a battery exchange station 6 as shown in FIGS. 7 and 8, comprising a vehicle lane 3 on which the electric vehicle V can advance in direction X. The vehicle lane 3 can be a raised ramp 30 on which the electric vehicle can roll from the level of ground 41, having an opening 31 for passing the battery block 1 therethrough when the battery block 1 is lifted for fitting in the battery dock 2. The ramp 30 may be supported by a supporting structure 32 of metal or else.

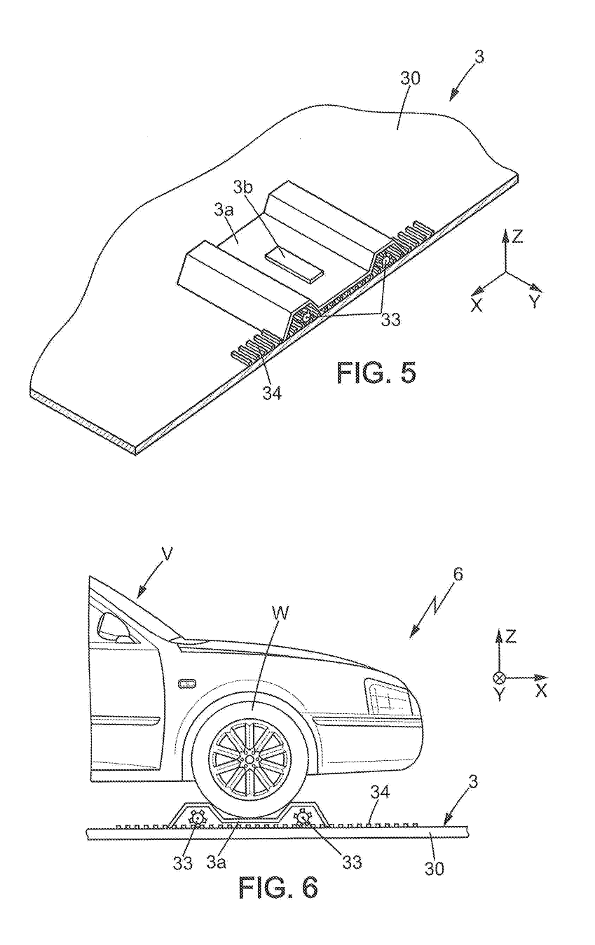

The vehicle lane 3 may include lateral guides for roughly positioning the electric vehicle V in direction Y. Further, as shown in more details in FIGS. 5 and 6, the vehicle lane 3 may be equipped with one or two front wheel blocking device(s) 3a for blocking the front wheels W of the electric vehicle when battery dock 2 is in register with opening 31. The blocking device 3a may be a cradle on which the electric vehicle can roll. The blocking device 3a may be equipped with a pressure sensor 3b connected to the control unit 5, for detecting a wheel W in said blocking device.

In case all vehicles V are identical or have identical distance from the front edge of the battery dock to the axis of the front wheels, the blocking mechanism may be fixed and non-adjustable.

In other examples, particularly when the electric vehicles may be of various types, the blocking device 3a may be adjustable in a front-rear direction, i.e. in direction X. Such adjustment may be carried out by an electrical adjustment mechanism 33 controlled for instance by control unit 5. In one example, the blocking device 3a is slidably guided on the ramp 30 in direction X and adjustment mechanism 33 may include for instance one or more pinion mounted in the blocking device 3a and meshing with a rack 34 extending parallel to direction X, for adjusting the position of the blocking device 3a.

The control unit 5 may be programmed to set the front wheel blocking device 3a to a required position according to the type of the electric vehicle.

For instance, the control unit may be programmed to set the position of the blocking device 3a at a distance k=x+b/2 from the center of the opening 31, where x is a distance between the front wheel axis and the front edge of the battery dock 2, and b is the length of the battery dock 2. The distance x is available in the vehicle documentation and may be memorized in advance in the control unit 5.

The vehicle type can be entered manually into the control unit 5 by the driver or an operator, or could be recognized automatically for instance through a camera communicating with the control unit 5.

When the battery exchange station is equipped with a card reader 50 adapted to read smart cards, the driver may have the vehicle particulars registered in the smart card, for instance said distance x. In that case, when the smart card is read by card reader 50 before the vehicle gets on the ramp 30, the distance is sent to the control unit 5 and the control unit sets the position of the blocking device 3a accordingly.

As shown on FIGS. 7 and 8, the battery exchange station 6 also includes a lift lane along which the battery lift 4 can move in direction Y perpendicularly to direction X. The lift lane can be materialized by one or two rails 40 on which the battery lift 4 can roll. The rails 40 may be at the level of the ground 41 and the ramp 30 is high enough so that the lift 4 may move under the vehicle lane. In a variant, the ramp 30 could be at ground level and the lift lane 40 underground.

The rails 40 are positioned under said opening 31 of the ramp 30.

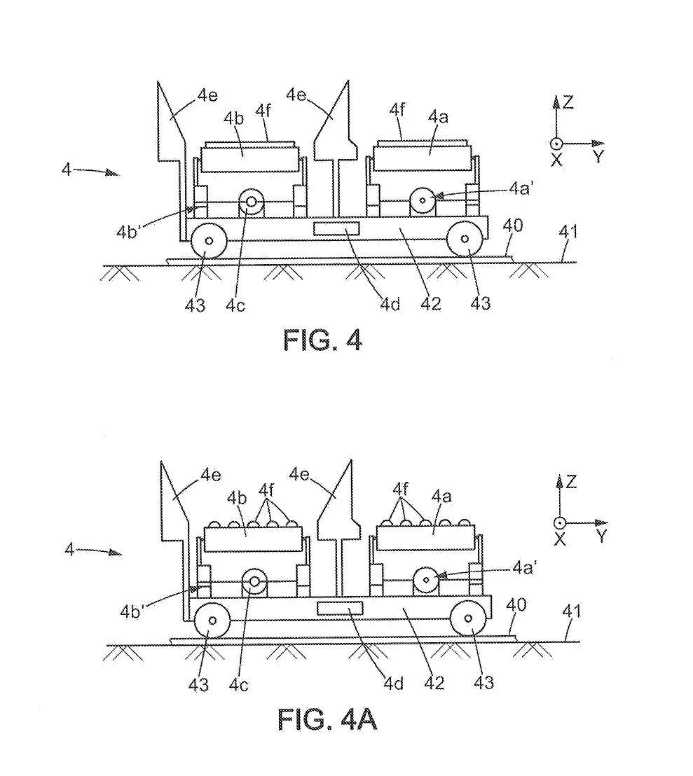

As shown on FIGS. 4, 7, 8, the battery lift 4 may include:
a first platform 4a (longitudinal pad) for supporting a charged battery block 1,
a first lift assembly 4a′ for raising and lowering the first platform 4a,
a second platform 4b (longitudinal pad) for supporting a discharged battery block 1,
a second lift assembly 4b′ for raising and lowering the second platform 4b.

The battery lift 4 may include a chassis 42 mounted by wheels 43 on the rails 40.

The battery lift 4 is thus able to transport battery blocks 1 from the charging storage to a place underneath the vehicle (a horizontal movement perpendicular to the axis of the vehicle) and then into the battery case 2 of the vehicle (a vertical movement). The battery lift 4 is driven on the rails 40 by its own power.

The battery lift 4 may be equipped with a position sensor 4c and a device 4d for communication with the control unit 5. The position sensor 4c may include a source of infrared beam and a detector able to detect reflection of the infrared beam by the mirror 1c of the battery block 1. The infrared beam can be replaced by an a laser beam.

The lift assemblies 4a′, 4b′ may comprise each four pistons driven by their own power (e.g. by a hydraulic compressor). In a variant, the lift assemblies 4a′, 4b′ may be jacks. Jacks are preferably selected for battery exchange stations where the lift lane 40 is located under the road surface, because they require less vertical space beneath the vehicle.

Both platforms 4a, 4b, and particularly platform 4a, may have a sliding surface to facilitate movement of the battery block 1 in the horizontal plane, either by sliding proper, or by rolling. Each platforms 4a, 4b may be formed for instance by a metal frame provided with rollers, for instance balls, or more preferably rolls 4f having axes of rotation parallel to direction Y (FIG. 4) or parallel to direction X (FIG. 4A). In the example of FIG. 4, the rolls 4a enable free rolling of the battery block 1 in direction X and free sliding of the battery block 1 in direction Y.

The rollers 4f could be replaced by any sliding surface, for instance a metallic surface or a surfaces coated with an antifriction material, i.e. a low friction material such as Teflon (R) or similar. These sliding surfaces may form the entire surfaces of said platforms 4a, 4b which may be flat or may be provided with sliding pads similar to those of FIG. 1B or sliding beads similar to those of FIG. 1C or other reliefs.

As a variant or in addition, the control unit 5 might be adapted to free the rotation of wheels 43 when the charged battery block 1 is lifted, to facilitate movement of the battery block 1 parallel to direction Y during fitting with the battery dock.

In this particular example, the platforms 4a, 4b slightly overlap the base 12 of the external casing 10 of the battery block 1 (for instance of 1 mm on each side).

The second platform 4b for the discharged battery block 1 is preferably equipped with a of funnel shaped guide 4e (having tapered sides), which allows for adjusting the position of the discharged battery block 1. The funnel shaped guide 4e has a sliding surface.

The control unit 5 is part of the battery exchange station and provides communication with the battery lift 4, the battery dock 2 and the blocking device 3a. It processes the sensor signals and based on them controls horizontal movement of the battery lift 4 and vertical movement of the lift assemblies 4a′, 4b′ and mechanical locks 2a of the battery case. Communication of the control unit 5 with the trolley 4 and the ramp 3 may be direct (wired), while communication of the control unit 5 with the battery dock 2 is preferably wireless.

Battery Exchange Process

The battery exchange system as described above operates as follows.

When an electric vehicle V enters the ramp 30, possibly after adjustment of the position of the blocking device 3a as explained above, the driver moves the vehicle forward until the front wheels W enter the blocking devices 3a and then stops the vehicle. The blocking devices 3a ensure a correct front-rear position of the electric vehicle V and thus of the discharged battery block 1 of the vehicle. The vehicle position is confirmed to the control unit 5 by a signal received from pressure sensor 3b.

The control unit 5 then sends a signal to the battery lift 4 (more particularly to one of the battery lifts of the battery exchange station 6) with a charged battery block 1 to move under the vehicle V, i.e. under opening 31.

The lateral orientation of the battery lift 4 is provided by the position sensor 4c of the trolley 4 and/or the position sensor 1c of the discharged battery 1. Data from position sensors are sent to the control unit 5 and when the position sensors 4c and 1c are directly above each other the control unit 5 sends an order to the battery lift 4 to stop.

After stopping, based on instructions of the control unit 5, the second lift assembly 4b′ extends vertically upward the second platform 4b and pushes the discharged battery 1 deeper upward into the battery dock 2 to activate the pressure sensor 2d. Based on a signal received from sensor 2d, the control unit 5 sends a signal to remove the locks 2a from the battery holes 1a, which releases the discharged battery block 1 from the battery case 2.

After the battery release, the control unit 5 gives an instruction to lower the second lift assembly 4b′ to move down the second platform 4b with discharged battery block 1.

When both down 4a, 4b are in the same low position, the control unit 5 has the battery lift 4 move parallel to direction Y by a constant predetermined distance so that the first platform 4a with the charged battery is directly beneath the battery dock 2.

The control unit 5 then (for instance with a delay of e.g. 5 seconds) instructs a release of mechanical locks 2a back to its extended (locked) position.

The charged battery block 1 is lifted on the first platform 4a (using the first lift assembly 4a′) and pushed into the battery dock 2 to force the mechanical locks 2a to enter the holes 1a on the sides of the battery block 1. Inserting the charged battery block 1 into the battery dock 2 is possible, even if the battery 1 is not perfectly aligned with the battery dock 2 (the tolerance can be for instance of +/−10 cm). This can be achieved due to the battery block tapered shape and the sliding surfaces of the battery dock 2, the tapered sides of the battery block 1 and the bottom of the battery block 1 freely moving on the first platform 4a.

Alignment of the electrical connectors 1b, 2b of charged battery block 1 and battery dock 2 result in their connection, which is confirmed to the control unit 5.

The control unit 5 then sends a signal to lower the first lift assembly 4a′ to its original low position.

Subsequently the control unit 5 may give an instruction to release the front wheel locking mechanism 3a, or the vehicle simply rolls thereon.

At the same time the control unit 5 instructs the battery lift 4 to return to the charging storage, where the discharged battery block 1 is removed from the second platform 4b, and another charged battery block 1 is loaded on the first platform 4a.

### Second Embodiment

The second embodiment of the invention is similar to the first embodiment described above, it will therefore not be described in all details. All details not described again for the second embodiment are identical or similar to the first embodiment.

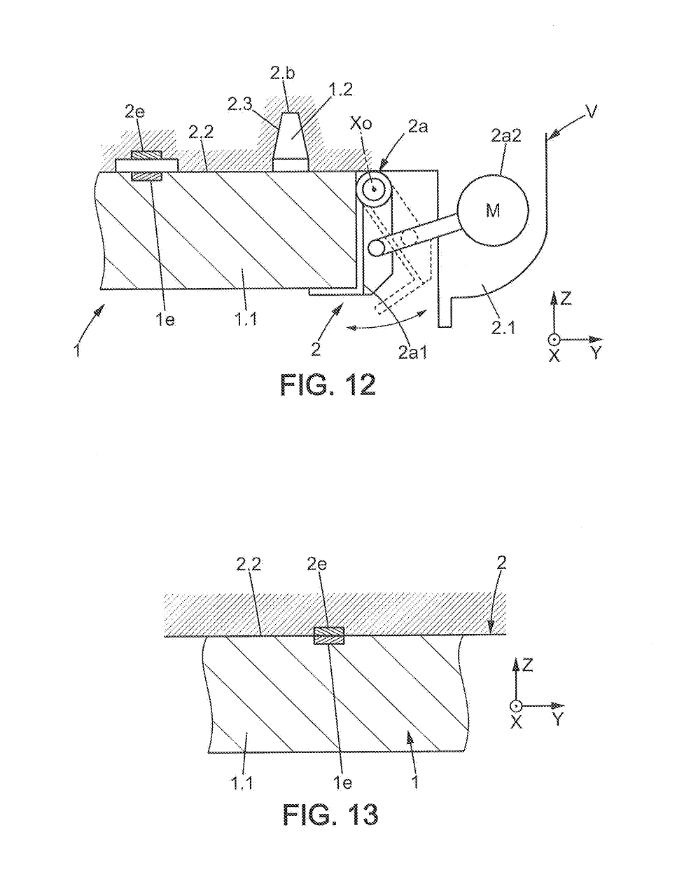

In the second embodiment, as shown in FIGS. 9-13, the battery block 1 has a shape of a flat block 1.1 having homing cones (conical studs) 1.2 placed on its upper side.

Example of dimensions of the battery bloc may be: length 3000 mm, width 1100 mm and thickness 100 mm. The dimensions of the battery block 1 are adapted according to the size of the electric vehicle V. The battery block 1 may extend approximately from 500 mm behind the front axle of the vehicle V to approximately 600 mm behind the rear axle. The width of the battery is set for allowing locking mechanical locks 2a from the battery dock, on both sides of the battery block 1.

The battery block may have four identical homing cones 1.2 placed on upper side of the battery block 1.1, two front cones and two rear cones. This number of homing cones 1.2 is favorable to obtain a proper guidance of the battery block in the horizontal plane when inserting the battery block into the battery dock of the vehicle. During this insertion, each homing cone 1.2 is fitted inside a conical hole 2.3 of corresponding shape belonging to the top portion 2.2 of the battery dock 2 (FIG. 12). During this insertion, the homing cones 1.2 slide inside the conical holes 2.3 to ensure horizontal guidance of the battery block 1 toward its proper position relative to the battery dock 2.

Relative to the vehicle V, the front homing cones 1.2 may be placed in a proximity of the front edge of the chassis on each side of the central tunnel and the rear homing cones 1.2 may be placed under the rear seats of the vehicle.

At least one pair of the homing cones 1.2 contains electric connector terminals 1b adapted to connect to complementary electrical connectors 2b formed in the corresponding conical holes 2.3. Homing cones 1.2 may also contain heating/cooling system connectors 1f for heating or cooling the battery block 1, adapted to connect with complementary heating/cooling system connectors (not shown) formed in the corresponding conical holes 2.3. Preferably the rear homing cones 1.2 contain electric connectors terminals 1b and the front homing cones 1.2 contain heating/cooling system connectors 1f.

Homing cones 1.2 are preferably in a shape of truncated cones with a cylindrical lower part, where the conical upper part is used for self-positioning of the battery block 1 during inserting into the battery dock of the vehicle and the lower cylindrical part is used for bringing the already centered battery block 1 to contact with electrical connectors 2b of the vehicle. Preferable dimensions of the homing cones may be: height approximately 150 mm and diameter approximately 120 mm.

A position sensor 1c may be located on the rear part of the battery block 1.1 between the two rear cones 1.2. It may be part of an optical sensor, e.g. in a form of a mirror or other reflection surface, while the battery dock 2 has a corresponding position sensor 2c (FIG. 12) having for instance a directive light emitter and a light detector to detect light reflected by the mirror 1c.

A connection sensor 1e may be located on the upper part of the battery block 1.1. It is preferably a ferromagnetic counterpart of a magneto inductive sensor 2e located in the top portion 2.2 of the battery dock 2 (FIG. 13).

The battery block 1 may be attached to the battery dock 2 by mechanical locks 2a. The mechanical locks 2a may be swinging locks extending on the sides 2.1 of the battery dock 2, formed for instance by a threshold of the car chassis.

As shown on FIG. 12, each mechanical lock 2a may include a latch 2a1 of L profile which is pivotally mounted in the battery dock 2 on a rotation axis X0 parallel to direction X. The latches are actuated by servomotors 2a2 placed for instance in the sides 2.1 of the battery dock 2, to rotate between an unlocked position (in dashed lines on FIG. 12) where the locks 2a release the battery block 1 and a locked position (in plain lines) where the latches 2al are applied on the sides of the battery block and under the battery block to hold said battery block 1 in the battery dock 2.

The battery dock 2 is formed on the vehicle chassis and has dimensions corresponding to the flat block 1.1 with a side tolerance of e.g. 40 mm during insertion of the battery block 1 in the battery dock 2.

In this embodiment, the first and second platforms 4a, 4b of the battery lift may be provided for instance with metal rollers 4f instead of silicone rollers. The metal rollers may be made for instance from steel with a zinc finish.

1. A battery exchange system for a battery powered electric vehicle, comprising:
an interchangeable battery block;
a battery dock defined at the underside of the electric vehicle and open downwards, said battery dock being adapted to receive the battery block for electrical and mechanical connection by vertical fitting when such battery is lifted from beneath the electric vehicle, said battery block being in a predetermined reference position, defined in a horizontal plane, relative to the electric vehicle when said battery block is electrically and mechanically connected to the battery dock;
a battery lift for lifting the battery block underneath the electric vehicle;
wherein:
said battery block has an external casing including a peripheral wall and said peripheral wall has a pyramid shaped part forming at least one bevel shaped male part;
said battery dock has an internal casing including an internal peripheral wall and said internal peripheral wall has a pyramid shaped internal part forming at least one bevel shaped female part;
said battery block and said battery dock have guides adapted to mutually cooperate for guiding the battery block horizontally toward the reference position when the battery block is lifted for fitting with the battery dock, wherein said guides include said at least one bevel shaped male part and said at least one bevel shaped female part which is adapted to receive said bevel shaped male part;
said guides include sliding surfaces which are adapted to slide on one another freely with low friction for said guiding of said battery block horizontally toward said reference position;
and in that the battery lift is adapted to let the battery block move freely horizontally relative to the electric vehicle when the battery block is lifted for fitting with the battery dock and guided horizontally toward the reference position.

2-5. (canceled)

6. A battery exchange system according to claim 1, wherein said battery block extends longitudinally in a first horizontal direction and said at least one bevel shaped male part tapers at least in a second horizontal direction substantially perpendicular to said first horizontal direction.

7-10. (canceled)

11. A battery exchange system according to claim 1, wherein said battery block extends longitudinally in a first horizontal direction and said at least one bevel shaped female part tapers at least in a second horizontal direction substantially perpendicular to said first horizontal direction.

12. (canceled)

13. A battery exchange system according to claim 1, wherein said guides include respectively at least a roller and a tapering surface on which said roller is adapted to roll for guiding the battery block horizontally toward the reference position.

14. A battery exchange system according to claim 1, wherein the battery lift is adapted to be freely movable horizontally relative to the electric vehicle when the battery block is lifted for fitting in the battery dock and guided horizontally toward the reference position.

15. A battery exchange system according to claim 1, wherein the battery lift includes a platform for supporting the battery block and a lift assembly for raising and lowering the platform, said battery block being freely movable horizontally on the platform.

16. A battery exchange system according to claim 7, wherein said battery block is horizontally slidable on the platform.

17. A battery exchange system according to claim 7, wherein said battery block is rollingly supported on the platform so as to be freely movable on the platform and wherein said platform has rollers.

18. (canceled)

19. A battery exchange system according to claim 9, wherein said battery block is rollingly supported on the platform in a first direction, said rollers extending in a second direction substantially perpendicular to the first direction and enabling free sliding of the battery block in the second direction.

20. A battery exchange system according to claim 1, further including a battery exchange station having:
a vehicle lane on which the electric vehicle can advance in a first horizontal direction;
a lift lane along which the battery lift can move in a second direction substantially perpendicular to the first direction, said lift lane being under the vehicle lane,
wherein the vehicle lane has an opening adapted to give free passage to the battery block when the battery block is lifted for fitting in the battery dock, said opening being in correspondence with the lift lane.

21. A battery exchange system according to claim 11, wherein the vehicle lane includes at least one wheel blocking device adapted to block the electric vehicle in a predetermined position suitable for battery exchange.

22. A battery exchange system according to claim 12, further including an adjustment mechanism for adjusting a position of the blocking device in a direction parallel to the vehicle lane.

23. (canceled)

24. A battery exchange system according to claim, wherein the battery lift is movable horizontally relative to the vehicle and the battery exchange system further includes:
at least a position sensor adapted to detect whether the battery block is properly positioned relative to the battery dock for lifting the battery block toward the battery dock,
a control system adapted to move the battery lift relative to the vehicle according to information received from said position sensor.

25. A battery exchange system according to claim, wherein the battery lift includes:
a first platform for supporting a charged battery block,
a first lift assembly for raising and lowering the first platform,
a second platform for supporting a discharged battery block,
a second lift assembly for raising and lowering the second platform.

26-27. (canceled)

28. A battery exchange system according to claim 1, wherein said sliding surfaces of said battery block guides include sliding pads.
